(19) United States
(12) Patent Application Publication
(10) Pub. No.: US 2026/0095003 A1
(43) Pub. Date: Apr. 2, 2026

(54) ELECTRICAL ADAPTER WITH SLEEVE

(71) Applicant: Lenovo (United States) Inc., Morrisville, NC (US)

(72) Inventor: Ghwang-Hyun Lim, Cary, NC (US)

(21) Appl. No.: 18/902,416

(22) Filed: Sep. 30, 2024

(51) Int. Cl. H01R 13/72; H01R 13/502; H01R 13/64; H01R 24/28; H01R 103/00

(52) U.S. Cl. CPC H01R 13/72; H01R 13/502; H01R 13/64; H01R 24/28; H01R 2103/00

(57) ABSTRACT

One embodiment provides a device, the device including: a body, wherein the body includes: a first end and a second end substantially opposite the first end, wherein the first end includes an outwardly facing face; and a middle portion extending between the first end and the second end, wherein the middle portion extends in a perpendicular direction with respect to the outwardly facing face of the first end; a sleeve, wherein the sleeve is movable to cover the middle portion; and a cord extending from the body. Other aspects are claimed and described.

### BACKGROUND

Devices that require power to operate often come with power plugs. Some of the devices may include a rechargeable battery that allows the device to be carried or moved to a different location and operate when not connected to an external power source, like an outlet. When the device is connected to an external power source, the device can operate using the external power source and the battery can be charged. However, not all devices can operate using the power provided by the external power source. For example, external power sources may provide alternating current (AC) power, but the device may only operate on direct current (DC) power. As another example, the external power source may provide power having certain power characteristics (e.g., frequency, wattage, amperage, etc.), but the device may only operate on power having different characteristics. Additionally, power characteristics of power provided by an external power source may be inconsistent. However, some devices are very sensitive to changes in the power being provided to the device. Thus, these devices do not have simply a power plug, but they also have a power adapter.

The power adapter includes components that can modify the characteristics of the power provided by the external power source to characteristics that are usable by the device, for example, by converting AC power to DC power, changing the power characteristics of the provided power, and/or the like. The adapter allows the device to utilize the power provided by the external power source by modifying the power to match the needs of the device.

### BRIEF SUMMARY

In summary, one aspect provides a device, the device including: a body, wherein the body includes: a first end and a second end substantially opposite the first end, wherein the first end includes an outwardly facing face; and a middle portion extending between the first end and the second end, wherein the middle portion extends in a perpendicular direction with respect to the outwardly facing face of the first end; a sleeve, wherein the sleeve is movable to cover the middle portion; and a cord extending from the body.

Another aspect provides a device, the device including: a body, wherein the body includes: a first end and a second end substantially opposite the first end, wherein the first end includes an outwardly facing face, wherein a cross sectional width dimension of the first end is greater than a cross sectional width dimension of the middle portion and a cross sectional width dimension of the second end; a middle portion extending between the first end and the second end, wherein the middle portion extends in a perpendicular direction with respect to the outwardly facing face of the first end; and electrical prongs located on an outwardly facing face of the second end; a sleeve, wherein the sleeve is movable along a lengthwise axis of the device to cover at least a portion of at least one of: the middle portion and the electrical prongs; and a cord electrically connected to the electrical prongs and extending from the middle portion of the body; wherein the electrical prongs extend through an opening in the sleeve when the sleeve covers the middle portion.

A further aspect provides an electrical adapter, the electrical adapter including: a body, wherein the body includes: a first end and a second end substantially opposite the first end, wherein the first end includes an outwardly facing face, wherein a cross sectional width dimension of the first end is greater than a cross sectional width dimension of the middle portion and a cross sectional width dimension of the second end; a middle portion extending between the first end and the second end, wherein the middle portion extends in a perpendicular direction with respect to the outwardly facing face of the first end; and electrical prongs located on an outwardly facing face of the second end; a sleeve, wherein the sleeve is movable to cover the middle portion, wherein an inner width dimension of the sleeve is less than an outer width dimension of the first end; and a cord electrically connected to the electrical prongs and extending from the middle portion of the body; wherein the electrical prongs extend through an opening in the sleeve when the sleeve covers the middle portion.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example contour illustration of a disassembled adapter having a sleeve and a body.

FIG. 4 illustrates an example illustration of an adapter when the sleeve is in the open position and the cord is wrapped around the middle portion of the adapter.

FIG. 5 illustrates an example illustration of the adapter of FIG. 4 when the cord is unwrapped from the middle portion of the adapter.

FIG. 6 illustrates an example illustration of the adapter of FIG. 4 when the sleeve is covering the middle portion and the cord is unwrapped from the body of the adapter.

### DETAILED DESCRIPTION

Many devices utilize power adapters. Particularly, electronic devices and information handling devices (e.g., laptop computers, tablets, smart phones, fitness trackers, smart watches, smart appliances, televisions, smart displays, displays, etc.) often have power adapters. Not only do these devices need power having specific characteristics, but these devices often include components that are very sensitive to changes in power characteristics. Thus, the power adapters allow users to utilize the devices in many different environments and connect these devices to any number of external power sources without having to be concerned about whether the device will function properly. However, these power adapters are generally bulky and ugly. Many of the power adapters are rectangular prisms that have a similar appearance to bricks, which is often used as a nickname to refer to the power adapter. Some power adapters for smaller devices may be smaller and more aesthetically pleasing.

Additionally, the cords tend to hang from the power adapters, which is particularly bothersome and cumbersome when the user is moving the device from one location to another and carrying the power adapter with the device. These cords can become a tangled mess that the user has to untangle the next time the user needs to use the power adapter. One solution to this problem is to attempt to wind or arrange the cord and then hold the arrangement with a tie. This sometimes works, but often different parts of the cord move out of place and the cord gets tangled again, particularly if the cord is placed in a bag or other carrying device where other objects might get caught within the cord and pull parts of the cord from the tie.

Accordingly, the described system provides a device having a body, a sleeve, and a cord. The body includes a first end and a second end substantially opposite the first end. Between the first end and the second end is a middle portion that extends in a perpendicular direction with respect to the outwardly facing face of the first end. The middle portion may connect the first end and the second end. Additionally, the middle portion may provide a portion of the device that the cord can be wrapped around when the cord is not in use. The device may include electrical prongs which could be removable from the body of the device or that may be integral to the body of the device. The cord could also be removable from the body of the device.

The sleeve may be movable over the device so that it covers the middle portion or uncovers the middle portion. Additionally, since the sleeve can move or slide over the device, the sleeve may only cover a portion of the middle portion while it is being moved. When not covering the middle portion, the sleeve may cover a portion or the entirety of the electrical prongs. Additionally, on a face of the device, information related to the adapter could be included so that a user can quickly identify what adapter may be used for what devices.

Thus, the described device provides an adapter that is less bulky and more aesthetically pleasing that traditional power adapters. Additionally, the adapter provides a location for the cord that allows the cord to remain wrapped while being transported, thereby preventing messy cord tangles and other objects from getting caught in the cord and causing the cord to become unwrapped or unwound. Thus, the described adapter provides a significant improvement to standard power adapters by making a more user friendly and neat adapter than conventional adapters.

The illustrated example embodiments will be best understood by reference to the figures. The following description is intended only by way of example, and simply illustrates certain example embodiments.

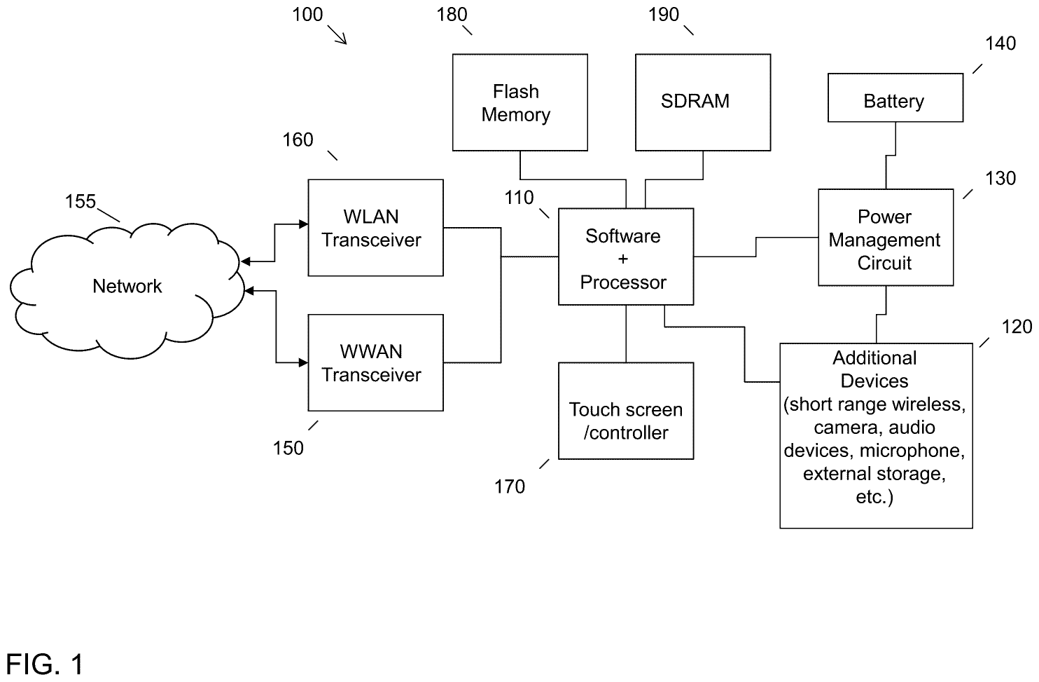

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

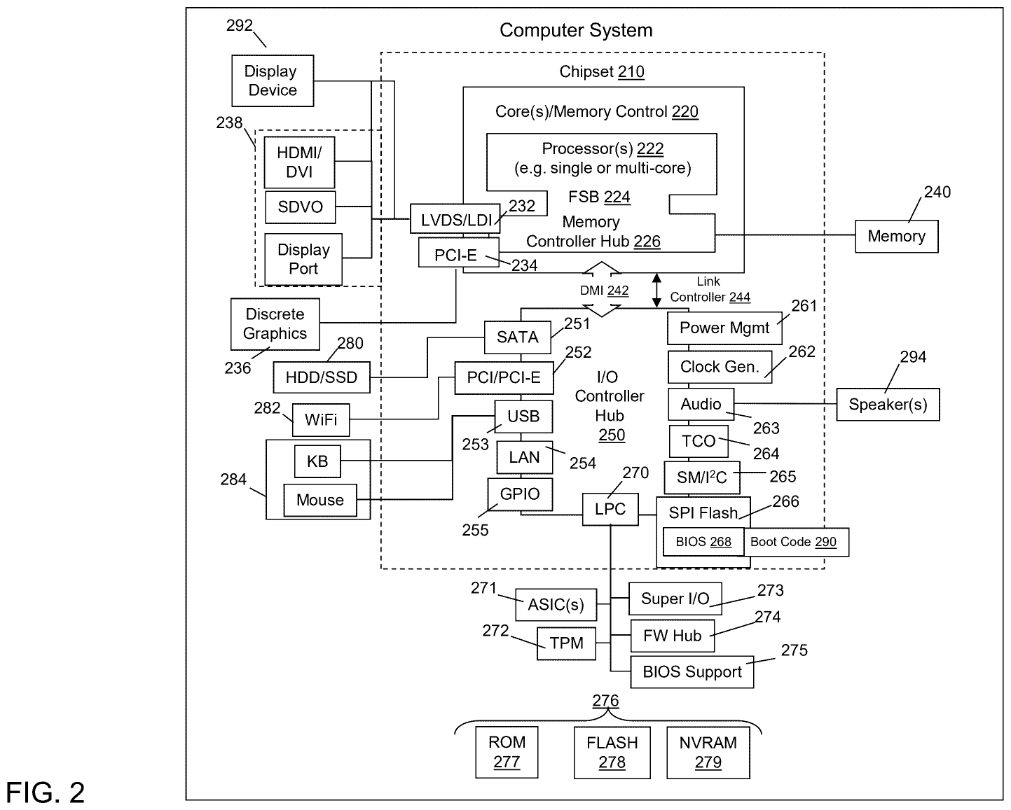

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may include or utilize adapter devices as described herein. For example, the circuitry outlined in FIG. 1 may be implemented in a tablet or smart phone embodiment, whereas the circuitry outlined in FIG. 2 may be implemented in a personal computer embodiment.

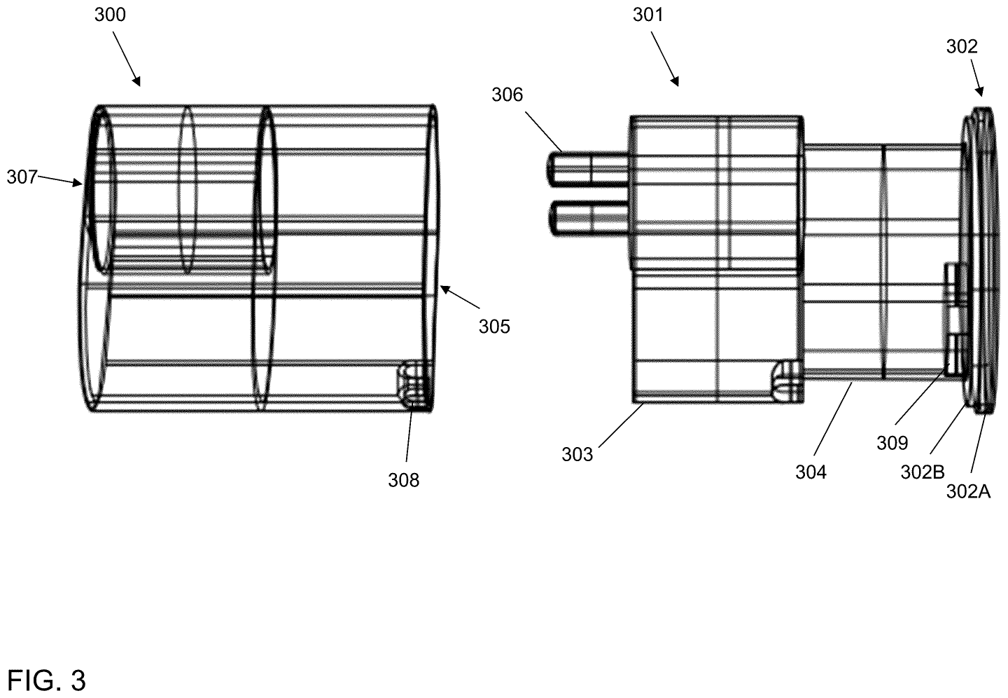

FIG. 3 illustrates an example disassembled adapter device. The device includes a sleeve 300 and a body 301. The sleeve 300 fits over the body 301. Thus, the opening 305 of the sleeve 300 is large enough to fit over portions of the body 301. The sleeve 300 slides on the body 301 starting with the second end 303 of the body 301. However, to ensure that the sleeve 300 does not slide off the first end 302 of the body 301, the opening 305 of the sleeve is smaller than the first end 302 of the body 301. In other words, the inner width dimension of the sleeve 300 is less than the outer width dimension of the first end 302. Thus, when the sleeve 300 is moved to a position where the end of the sleeve is touching the first end 302, the first end 302 will cover the opening 305 of the sleeve.

Illustrated in FIG. 3, the first end 302 includes two portions 302A and 302B. The inner of the two portions 302B may be of the same size and shape as the opening 305 of the sleeve 300. The outer of the two portions 302A may be of a larger size than the opening 305 of the sleeve 300. Thus, when the sleeve 300 is positioned to cover the middle portion 304, the sleeve may also cover the inner of the two portions 302B, but the outer of the two portions 302A may cover the opening 305 of the sleeve 300 and prevent the sleeve 300 from being moved past the first end 302. The inner of the two portions 302B may also include some holding mechanisms that may interface with corresponding portions of the sleeve 300. For example, at least one of the inner of the two portions 302B and an interior or end of the sleeve 300 may have nubs and recesses. When the sleeve 300 is positioned to cover the inner of the two portions 302B, the nubs and recesses may work together to hold the sleeve 300 in position so that it does not slide or move away from the first end 302 when the user does not want it to. Other holding mechanisms may be utilized, for example, latches, snaps, a holding mechanism located on the outside of the sleeve (e.g., tape, protrusions and a flexible material that loops around the protrusions, hook and loop fasteners, etc.), and/or the like.

While FIG. 3 illustrates the adapter device as two separate disassembled pieces, the sleeve 300 and the body 301, the sleeve 300 and/or body 301 may include holding mechanisms that prevent the sleeve 300 from being removed from the body 301 once assembled. In other words, the device may be designed so that the sleeve 300 does not fall off the body 301 once the device has been assembled. Accordingly, the sleeve 300 and/or body 301 could include ridges, nubs and recesses, and/or other holding mechanisms. The sleeve 300 and body 301 could also be assembled using a technique that prevents the two pieces from being disassembled after being assembled. For example, the sleeve 300 and body 301 could be heated to provide some malleability when assembling the device, but when cooled prevents the pieces from being disassembled. As another example, the sleeve 300 and body 301 could be pressure-fitted together when the parts are assembled using a force or pressure that snaps the pieces together, but that prevents the pieces from being pulled apart under normal use.

The sleeve 300, when assembled with the body 301, is movable across the body 301 so as to cover or uncover the middle portion 304. The sleeve 300 is movable along a lengthwise axis of the device to cover the middle portion 304. In other words, the sleeve 300 moves along a length of the device towards or away from the first end 302. The sleeve 300 is considered open when it is at the farthest left position in view of FIG. 3. In other words, in FIG. 3, the second end 303 is on the left side of the device and the first end 302 is on the right side of the device. Thus, when the sleeve 300 is at the farthest left position (i.e., being as far from the first end 302 as allowed), the sleeve 300 is considered to be in the open position. Conversely, when the sleeve 300 is at the further right position (i.e., being as close to the first end 302 as allowed), the sleeve 300 is considered to be in a closed position. Positions of the sleeve 300 therebetween would be considered partially open or partially closed. As could be understood, the device could be flipped over and the left and right directions would be reversed. When the sleeve 300 is in a completely closed position, the middle portion 304 is completely enclosed by the sleeve 300. In this closed position, the sleeve may contact the first end 302 or a portion thereof.

When the sleeve 300 is in a completely open position, the middle portion 304 is as uncovered by the sleeve 300 as possible. The device may include holding mechanisms, for example, those previously discussed, that can hold the sleeve 300 in the open position so that it does not close when the user does not want it closed. When the sleeve 300 is in the completely open position, the sleeve 300 may cover electrical prongs 306 that may be included on the device. The sleeve 300 may include an opening 307 that allows the electrical prongs 306 to protrude outside the sleeve 300 when the sleeve 300 is in or moving towards the closed position. In other words, the sleeve 300 may include an opening 307 that allows the sleeve 300 to move along the body 301 without interfering the electrical prongs 306. Thus, when the sleeve 300 is in the open position, it can hide the electrical prongs 306. This may assist in preventing damage to the electrical prongs 306, prevent the user from contacting the electrical prongs 306, may make the device more aesthetically pleasing because the electrical prongs 306 are not visible, and/or the like. When the sleeve 300 is in a partially open or partially closed position, a portion of the middle portion 304 and a portion of the electrical prongs 306 may be covered by the sleeve 300.

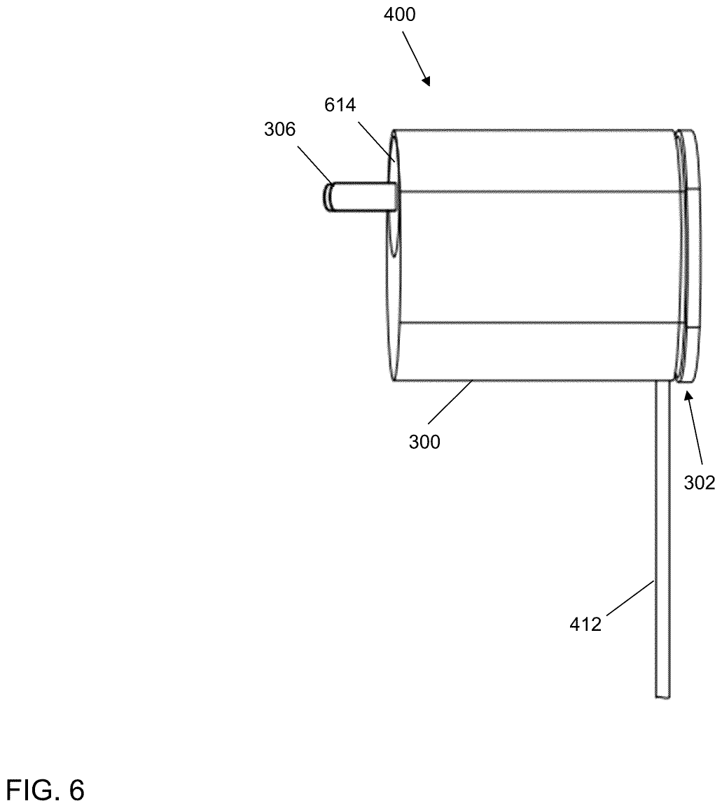

The electrical prongs 306 may be located on the body 301 such that they are located on an outwardly facing face of the second end 303. In other words, the electrical prongs 306 may be located on a face of the body 301 that is substantially opposite the outwardly facing face 410 of the first end 302. The second end 303 may also include a protrusion (illustrated in FIG. 6 at 614) on the outwardly facing face of the second end 303, and the electrical prongs 306 may be located on this protrusion. The protrusion may be of a shape that matches the shape of the opening 307 in the sleeve 300. Additionally, a height of the protrusion (i.e., the dimension of the protrusion from the outwardly facing face of the second end 303 and the outwardly facing face of the protrusion) may be equal to the thickness of the face of the sleeve 300 that includes the opening 307. Alternatively, the height of the protrusion may be less than or greater than the thickness of the face of the sleeve 300 that includes the opening 307. Thus, a portion of the second end 303 may extend through the opening 307 in the sleeve 300.

While the electrical prongs 306 may be integral to the body 300 and/or the second end 303, the electrical prongs 306 may also be detachable or removable from the second end 303 or body 300. This may be useful in the case that the adapter could be utilized in different countries that may have different electrical outlet configurations which could include a different number of electrical prongs, a different shape of electrical prongs, different configurations of the electrical prongs, and/or the like. Thus, instead of requiring a different adapter for each country, the electrical prongs 306 could be removed and replaced with electrical prongs 306 appropriate for a particular outlet configuration. In the case that the electrical prongs 306 are removable from the adapter, the body 300 and a base that holds the electrical prongs 306 may have corresponding mechanisms that allow for the connection and removal of the base of the electrical prongs 306 to the body 300. Such mechanisms may include protrusions and recesses that allow for the base to be slid on or off the body 300, latches and receivers that connect and hold the base to the body 300, snaps and receivers that connect and hold the base to the body 300, screw mechanisms and receivers that allow for the base to be screwed on the body 300, and/or the like.

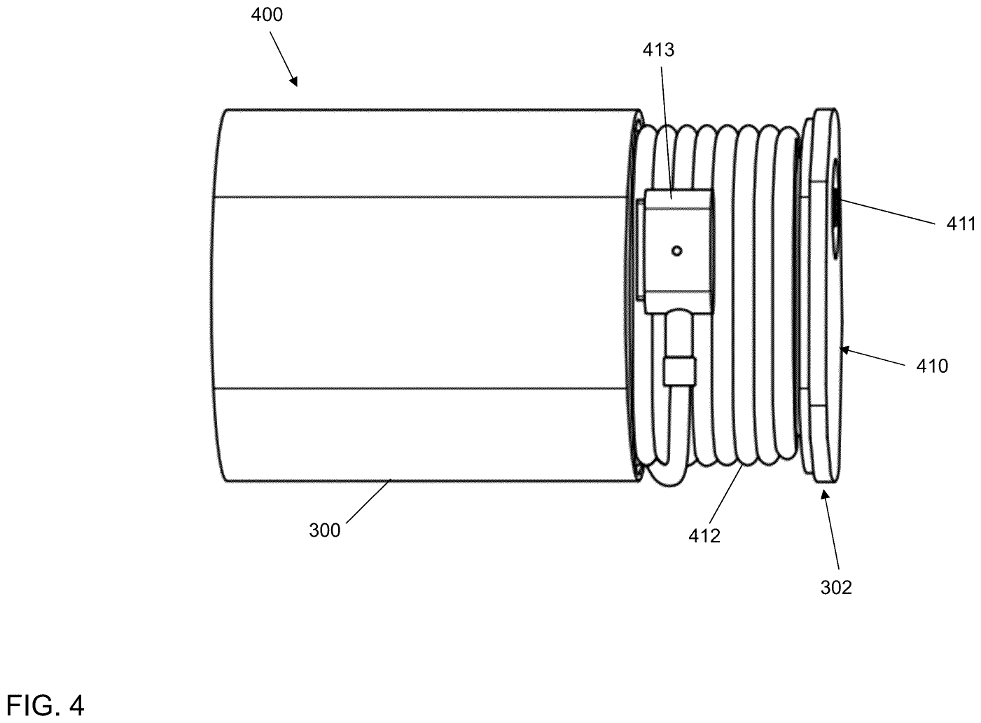

The body 301 may include a first end 302 and a second end 303. The first end 302 may include an outwardly facing face illustrated in FIG. 4 at 410. The second end 303 may be substantially opposite the first end 302. In other words, the first end 302 and the second end 303 may be on opposite sides of the body 301. Between the first end 302 and the second end 303 may be a middle portion 304. In other words, the middle portion 304 may extend between the first end 302 and the second end 303. The middle portion 304 may extend in a perpendicular direction with respect to the outwardly facing face 410 of the first end 302. While the outwardly facing face 410 of the first end 302 is on the outside of the device, the middle portion 304 is in the interior of the device. In other words, while the middle portion 304 extends in a perpendicular direction with respect to the outwardly facing face 410, the middle portion 304 does not touch or is not connected to the outwardly facing face 410.

A cross sectional dimension of the middle portion 304 may be smaller than a cross sectional dimension of the first end 302. In other words, the middle portion 304 has a smaller diameter, a smaller width, a smaller height, and/or the like, as compared to the same dimension of the first end 302 and the same dimension of the second end 303. The middle portion 304 may be smaller than both the first end 302 and the second end 303 so that a cord (illustrated at 412 in FIG. 4-6) can be wrapped around the middle portion 304. The size difference between the middle portion 304 and the first end 302 and second end 303 may be such that the cord 412 can be wrapped around the middle portion 304 and the sleeve 300 could still be moved to the closed position. In other words, a size difference between the middle portion 304 and the first end 302 and the second end 303 may be of an amount to account for the dimensions of the cord 412. When the cord 412 is wrapped around the middle portion 304, the first end 302 and the second end 303 may hold the cord 412 onto the device. In other words, the first end 302 and the second end 303 may prevent the cord 412 from falling off the middle portion 304 of the device.

Thus, a size of the second end 303 may be similar to a size of the inner of the two portions 302B of the first end 302. In other words, an outside-to-outside dimension of the second end 303 may be equal to or less than the inside-to-inside dimension of the sleeve opening 305. Thus, a cross sectional width dimension of the second end 303 is smaller than a cross sectional width dimension of the first end 302. However, the cross-sectional width dimension of the second end 303 may be larger than the cross-sectional width dimension of the middle portion 304. Additionally, a shape of the second end 303 may match the shape of at least a portion of the interior of the sleeve 300. In other words, the second end 303 may have a shape that matches an interior of the sleeve 300 where the second end 303 would be located when the sleeve 300 is closed and cover the middle portion 304 of the body.

The cord 412 may be attached to a point 309 of the middle portion 304. However, other configurations are contemplated and possible. Since the cord 412 extends from the body 301, the sleeve 300 may include an opening 308 that allows the cord 412 to extend from the body 301 to outside the sleeve 300. The opening 308 may be located in a location on the sleeve 300 at a location near where the cord 412 connects to the body 301.

The cord 412 may be integral to the device or may be detachable or removable from the device. In the case that the cord 412 is removable, the body 301 may include a connector or receptacle that holds an end of the cord 412. The end of the cord 412 may include a corresponding connector or receptacle that connects to the connector or receptacle of the body 301. A removable cord allows for the connection of cords 412 that may have different device connectors (i.e., the end of the cord that connects to an information handling device), replacement of a worn or damaged cord, and/or the like. The connector and corresponding receptacle of the cord 412 and body 301 may be designed so that cord 412 does not fall off the body 301. Thus, the connector and receptacle combination could include a friction holding mechanism, may include latches or snaps to hold the cord 412 to the body, may include nubs and recesses to hold the cord 412 to the body, and/or the like.

The body 301 may be hollow or partially hollow. Within the body 301 may be electrical components for performing the functions of the adapter. In other words, the electrical components that are needed to change the characteristics of the power that is provided by the external power source through the electrical prongs 306 may be enclosed within the body 301 of the adapter. Thus, while the cord 411 is electrically connected to the electrical prongs 306, they are likely not directly connected. Rather, between the end of the cord 411 and the electrical prongs 306 may be other electrical components that modify the characteristics of the power provided by the external power source.

Different parts of the device may be made from different materials. For example, the sleeve 300 and body 301 could be made from plastic, metal, wood, and/or the like. The electrical prongs 306 may be made from a conductive metal and may be plated. For example, the prongs 306 may be made from copper, brass, alloys, stainless steel, and/or the like, and may be coated in nickel, gold, tin, and/or the like. The cord 411 may be made of a combination of materials, for example, metal wires to conduct electricity, plastic wrapping to protect users from electrical shock, and/or the like.

FIG. 4 illustrates an example illustration of an adapter 400 when the sleeve 300 is in the open position and the cord 412 is wrapped around the middle portion (hidden by the cord 412 in FIG. 4) of the adapter 400. As illustrated in FIG. 4, the cord 412 is wrapped around the middle portion and the device connector 413 of the cord is visible. The device connector 413 is the portion of the cord 412 that connects to an information handling device. The cord 412 may include a component that holds an end of the cord 412 to another portion of the cord 412. In other words, the cord 412 may include a component that allows the cord 412 to be held to itself so that it does not unwind from the device. Such a component may include a latch, hand or finger connector that wraps around another portion of the cord, a fastener that sticks to a portion of the cord, and/or the like.

Also illustrated in FIG. 4 is the outwardly facing face 410 of the first end 302 that includes information 411 related to the device 400. The information 411 related to the device could include any information that may be useful to the user at a quick glance. Thus, the information 411 may include an identification of a power value or wattage supported by the adapter 400, a current rating or amperage of the adapter 400, a device identifier that identifies the information handling device that the adapter 400 is associated with, user provided or designated information, and/or the like.

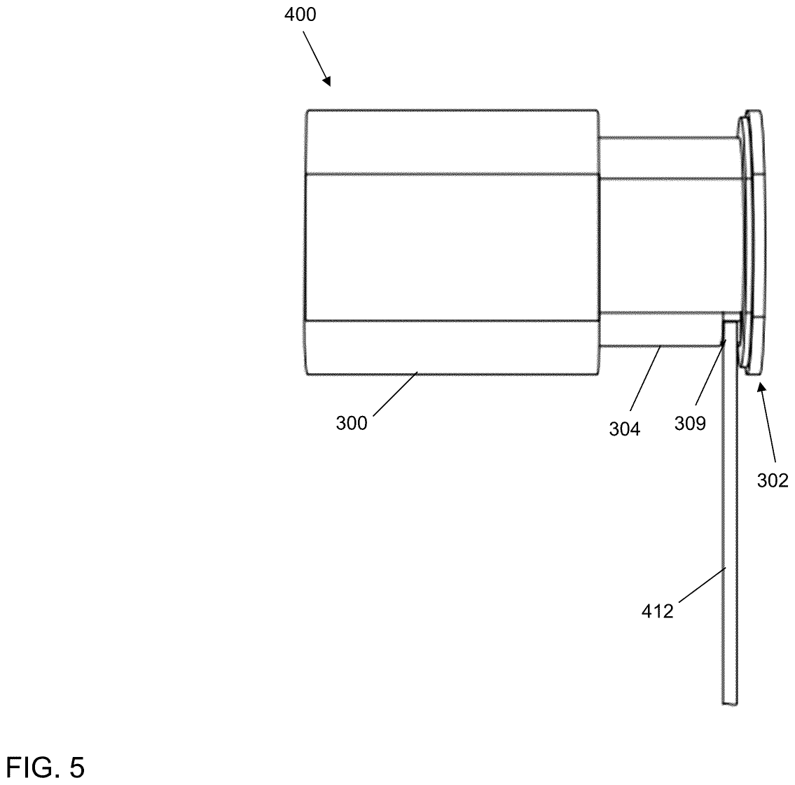

FIG. 5 illustrates an example illustration of the adapter 400 when the cord 412 is unwrapped from the middle portion of the adapter 400. As illustrated in FIG. 5, the cord 412 connects at a point 309 of the middle portion 304. In this example, the sleeve 300 is in the open position. FIG. 6 illustrates an example illustration of the adapter 400 when the sleeve 300 is covering the middle portion (not illustrated in this FIG.) and the cord 412 is unwrapped from the body 301 (not illustrated in this FIG.) of the adapter 400. Since the cord 412 is connected to the middle portion and extends outside the sleeve 300, the sleeve 300 includes an opening to allow the cord 412 to extend outside the sleeve 300. In the example of FIG. 6, the sleeve 300 is in a closed position and the electrical prongs 306 are outside the sleeve 300.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more”unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A device, the device comprising:
a body, wherein the body comprises:
a first end and a second end substantially opposite the first end, wherein the first end comprises an outwardly facing face; and
a middle portion extending between the first end and the second end, wherein the middle portion extends in a perpendicular direction with respect to the outwardly facing face of the first end;
a sleeve, wherein the sleeve is movable to cover the middle portion; and
a cord extending from the body.

2. The device of claim 1, wherein a cross sectional dimension of the middle portion is smaller than a cross sectional dimension of the first end.

3. The device of claim 1, wherein the sleeve comprises an opening for the cord to extend outside the sleeve from the body.

4. The device of claim 1, further comprising electrical prongs located on the second end.

5. The device of claim 4, wherein the electrical prongs are removable from the second end.

6. The device of claim 4, wherein the second end comprises a protrusion and wherein the electrical prongs are located on a face of the protrusion.

7. The device of claim 1, wherein a portion of the second end extends through an opening in the sleeve when the sleeve covers the middle portion.

8. The device of claim 1, wherein a portion of the first end contacts the sleeve when the sleeve covers the middle portion.

9. The device of claim 1, wherein the cord extends from a point of the middle portion.

10. The device of claim 1, wherein the cord wraps around the middle portion and is held onto the device via the first end and the second end.

11. The device of claim 1, wherein the cord is detachable from the body.

12. The device of claim 1, wherein the outwardly facing face comprises information related to the device.

13. A device, the device comprising:
a body, wherein the body comprises:
a first end and a second end substantially opposite the first end, wherein the first end comprises an outwardly facing face, wherein a cross sectional width dimension of the first end is greater than a cross sectional width dimension of the middle portion and a cross sectional width dimension of the second end;
a middle portion extending between the first end and the second end, wherein the middle portion extends in a perpendicular direction with respect to the outwardly facing face of the first end; and
electrical prongs located on an outwardly facing face of the second end;
a sleeve, wherein the sleeve is movable along a lengthwise axis of the device to cover at least a portion of at least one of: the middle portion and the electrical prongs; and
a cord electrically connected to the electrical prongs and extending from the middle portion of the body;
wherein the electrical prongs extend through an opening in the sleeve when the sleeve covers the middle portion.

14. The device of claim 13, wherein the sleeve comprises an opening for the cord to extend outside the sleeve from the body.

15. The device of claim 13, wherein the second end comprises a protrusion and wherein the electrical prongs are located on a face of the protrusion.

16. The device of claim 13, wherein a portion of the second end extends through an opening in the sleeve when the sleeve covers the middle portion.

17. The device of claim 13, wherein a portion of the first end contacts the sleeve when the sleeve covers the middle portion.

18. The device of claim 13, wherein the cord wraps around the middle portion and is held onto the device via the first end and the second end.

19. The device of claim 13, wherein the outwardly facing face comprises information related to the device.

20. An electrical adapter, the electrical adapter comprising:
a body, wherein the body comprises:
a first end and a second end substantially opposite the first end, wherein the first end comprises an outwardly facing face, wherein a cross sectional width dimension of the first end is greater than a cross sectional width dimension of the middle portion and a cross sectional width dimension of the second end;
a middle portion extending between the first end and the second end, wherein the middle portion extends in a perpendicular direction with respect to the outwardly facing face of the first end; and
electrical prongs located on an outwardly facing face of the second end;
a sleeve, wherein the sleeve is movable to cover the middle portion, wherein an inner width dimension of the sleeve is less than an outer width dimension of the first end; and
a cord electrically connected to the electrical prongs and extending from the middle portion of the body;
wherein the electrical prongs extend through an opening in the sleeve when the sleeve covers the middle portion.
